(19) United States
(12) Patent Application Publication
(10) Pub. No.: US 2024/0307149 A1
(43) Pub. Date: Sep. 19, 2024

(54) DENTAL PREPARATION CUFF

(71) Applicants: Susanne LEMELSON, Idstein (DE); RAUMEDIC AG, Münchberg (DE)

(72) Inventors: Susanne LEMELSON, Idstein (DE); Karsten WAGNER, Hünstetten (DE); Tobias FESTEL, Sparneck (DE); Björn GLÄSEL, Kirchenlamitz (DE); Adnan ÖZTÜRK, Delmenhorst (DE)

(73) Assignees: Susanne LEMELSON, Idstein (DE); RAUMEDIC AG, Münchberg (DE)

(21) Appl. No.: 18/275,413

(22) PCT Filed: Dec. 17, 2021
(86) PCT No.: PCT/EP2021/086526

§ 371 Date: Aug. 2, 2023

(30) Foreign Application Priority Data
Feb. 4, 2021 (DE) 10 2021 201 056.3

(51) Int. Cl. A61C 5/85

(52) U.S. Cl. CPC A61C 5/85

(57) ABSTRACT

A dental preparation cuff is used to expose a transition region (preparation margin) between a tooth neck of a prepared tooth and surrounding gums. The preparation cuff has a tooth opening to place on the tooth, having a peripheral wall with a cross-sectionally wedge-shaped, radially inwardly tapering edge region. The preparation cuff is manufactured from a material with a Shore hardness in the range between 70A and 95A. This results in a preparation cuff providing improved patient tolerability.

### CROSS-REFERENCES TO RELATED APPLICATIONS

This application claims the priority of German Patent Application, Serial No. DE 10 2021 201 056.3, filed Feb. 4, 2021, the content of which is incorporated herein by reference in its entirety as if fully set forth herein.

### FIELD OF THE INVENTION

The invention relates to a dental preparation cuff for exposing a transition region (preparation margin) between a tooth neck of a prepared tooth and surrounding gums.

### BACKGROUND OF THE INVENTION

Such a preparation cuff is known from the market. DE 74 34 552 U discloses a ring-shaped aid for an impression of dental crown dies. US 2007/0160952 A1 discloses a method for gum displacement. US 2004/0265777 A1 and U.S. Pat. No. 8,118,595 B2 disclose preparation means for displacing gingiva in preparation for an impression.

### SUMMARY OF THE INVENTION

It is an object of the present invention to further embody a preparation cuff of the type mentioned above in such a manner that its patient tolerability is improved.

This object is achieved according to the invention by a preparation cuff for exposing a transition region (preparation margin) between a tooth neck of a prepared tooth and surrounding gums, having a tooth opening to place on the tooth, having a peripheral wall with a cross-sectionally wedge-shaped, radially inwardly tapering edge region, manufactured from a material having a shore hardness in the range between 70A and 95A.

According to the invention, it has been recognized that a preparation cuff manufactured from a material with a defined shore hardness can be designed to be gentle on the gums in particular, but also gentle on the teeth. The transition region between the neck of the tooth to be prepared and the surrounding gum, also known as the preparation margin, can be gently exposed. The Shore hardness of the material is in the range between 70A and 95A and can be in the range between 75A and 90A, especially in the range of 80A. The material may be a thermoplastic elastomer (TPE). The material may be a polyurethane (PUR), a polyethylene (PE), a polypropylene (PP), a polyether block amide (PEBAX, PEBA) or a silicone (SIK). The preparation cuff can be manufactured by injection molding. Alternatively, the preparation cuff can also be produced using an extrusion process.

The preparation cuff can also be used to expose a transition region between the neck of a tooth to be prepared and the surrounding gums. In the case of a preparation cuff produced by injection molding, the possibility of adapting the cuff to a particular tooth anatomy arises in particular through a material flexibility that is then preferably available and when using a basic cuff size.

The edge region of the tooth opening, which is wedge-shaped in cross-section and tapers radially inwards, serves to lift off or move the gingiva surrounding the preparation margin.

The preparation cuff can be designed as a bottomless collar or as a sleeve with a bottom, in which the tooth opening is formed as a blind hole.

The preparation cuff can be used several times after appropriate sterilization.

The preparation cuff may have a safety component that protrudes or overlaps and can serve as protection against loss or swallowing. Such a safety component can be designed as a safety loop. The safety component can be directly molded onto the preparation cuff. The safety component is preferably attached to the preparation cuff in a manner spaced apart from the margin region. The safety component can be manufactured from the same material as the preparation cuff, but can also be manufactured from a different material, in particular with a different Shore hardness. In such a case, the preparation cuff can be produced together with the safety component in a 2C method.

At least one recess in an outer wedge wall portion of the peripheral wall of the preparation cuff which is set back with respect to the surrounding wedge wall portion can be used for wetting and/or loading the preparation cuff, in particular with a medicament, for example in the form of an astringent liquid, a gel or an ointment, for example, which helps to further improve patient tolerability of the preparation cuff. The preparation cuff may have more than 5, more than 10 and, for example, 16 recesses of this type. A much larger number of such recesses is also possible, for example several hundred such recesses. The number of such recesses may be 500, for example. Corresponding recesses in the outer wedge wall portion of the peripheral wall can also be formed by structuring the wedge wall portion. Such structuring may be regular, for example in the manner of a grid, or irregular. The recess can be designed with an atraumatic radius in order to avoid irritation of the patient. Alternatively, such an atraumatic radius can be omitted.

A circumferential inner web which remains between the at least one recess and an inner peripheral edge region of the peripheral wall, which bounds a circumference of the tooth opening, and/or a circumferential outer web which remains between the at least one recess and an outer peripheral edge region of the peripheral wall, which bounds an outer circumference of the preparation cuff in the region of the tooth opening, provide a boundary on the edge of the recess and thus facilitate loading of the recess. In addition, a section of the outer wedge wall portion remains in the region of these webs in each case, so that the function of the outer wedge wall portion is not impaired when the transition region is exposed.

In principle, the peripheral wall of the preparation cuff may have a circular cross-section. A cross-section of the peripheral wall that deviates from a circular shape or an elliptical cross-section of the peripheral wall with a main axis ratio (L/K) in the range between 1.1 and 1.5 may be well adapted to a tooth anatomy. A main axis ratio of the elliptical cross-section may be in the range between 1.3 and 1.4 and may be, for example, 1.35. Alternatively, the peripheral wall may have an oval cross-section.

A peripheral wall having a wave-shaped axial contour with two axial maximum extension regions and two axial minimum extension regions is well adapted to a tooth anatomy.

This applies in particular to an axial spacing of the axial extension regions of the wave-shaped axial contour between the maximum extension regions on the one hand and the minimum extension regions on the other hand, implemented in the range between 0.8 times and 1.2 times a smaller main axis extension of the elliptical cross-section of the peripheral wall.

A bottom thickness of a tooth opening bottom which is greater than a quarter of a total axial extension of the preparation cuff perpendicular to a bottom surface of the bottom leads to an advantageous basic stability of the preparation cuff without losing flexibility when adapting to the respective tooth. Such a bottom thickness can in particular provide dimensional stability of the preparation cuff so that the preparation cuff does not deform in an undesirable manner, for example due to biting pressure.

A thickness of the bottom can be in the range between 0.25 and 0.4 of the total axial extension of the preparation cuff. Other ratios of the thickness of the bottom to the total axial extension of the preparation cuff in the range between 0.15 and 0.25, in the range between 0.2 and 0.3, in the range between 0.25 and 0.35 and in the range between 0.3 and 0.4 are also possible.

A preparation cuff which is manufactured by a 3D printing method is customizable to fit a tooth anatomy. The preparation cuff may be manufactured using a computer-aided design (CAD) preparation step.

Computer-aided manufacturing (CAM) methods may be used in the production of the preparation cuff. Here, the geometry data for the preparation cuff can be read in from the CAD. Depending on the application, the geometry of the preparation cuff that results from the CAD data can still be modified. As an alternative to a 3D printing method, the preparation cuff can also be produced by an injection molding method and an extrusion or compression molding method.

A set of multiple preparation cuffs with different widths and/or different depths of the tooth openings and/or with different axial spacings between the maximum extension regions and the minimum extension regions facilitates the fitting of a respective preparation cuff to an individual tooth to be treated. In each case, the preparation cuff having a tooth opening with a slight undersize compared to the outer circumference of the tooth to be treated can be selected, which ensures a good fitting of the preparation cuff to the tooth neck of the tooth and a correspondingly good exposure of the transition region. The set can have between two and more than 20, for example 40, different preparation cuffs. An even larger number of different preparation cuffs as components of a set is also possible. Alternatively, the preparation cuffs can also be produced and used singly.

An embodiment of the invention is explained in more detail below with reference to the drawing.

### BRIEF DESCRIPTION OF THE DRAWING

FIG. 1 shows a perspective view of a dental preparation cuff for exposing a transition region (preparation margin) between a tooth neck of a prepared tooth and surrounding gums;

FIG. 2 shows a plan view of the preparation cuff according to FIG. 1;

FIG. 3 shows a section according to line III-III in FIG. 2;

FIG. 4 shows a section according to line IV-IV in FIG. 2;

FIG. 5 shows a detail enlargement of the detail V in FIG. 2; and

FIG. 6 shows the preparation cuff in position placed on a prepared tooth in a patient's mouth.

### DESCRIPTION OF THE PREFERRED EMBODIMENT

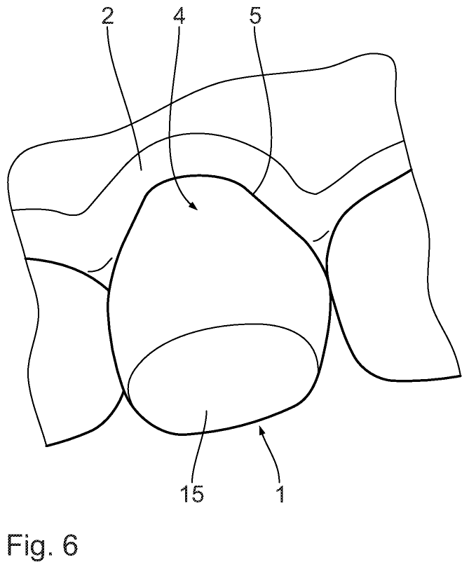

A dental preparation cuff 1 serves to expose a transition region (preparation margin) between a tooth neck of a prepared tooth and surrounding gums 2 of a patient (cf. FIG. 6).

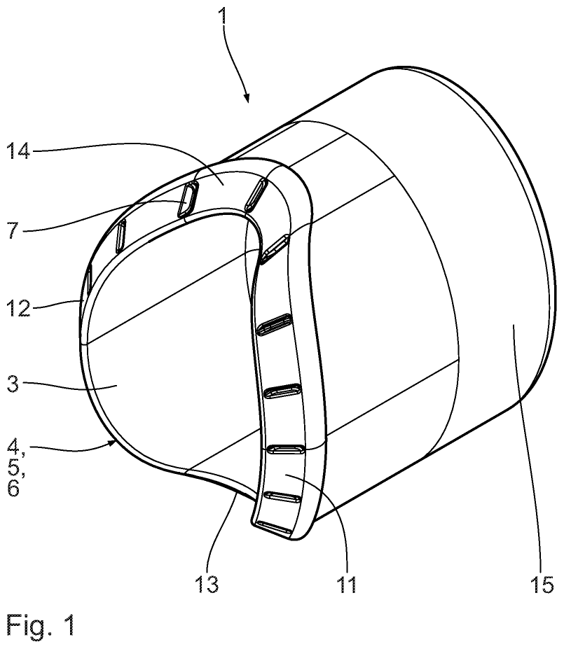

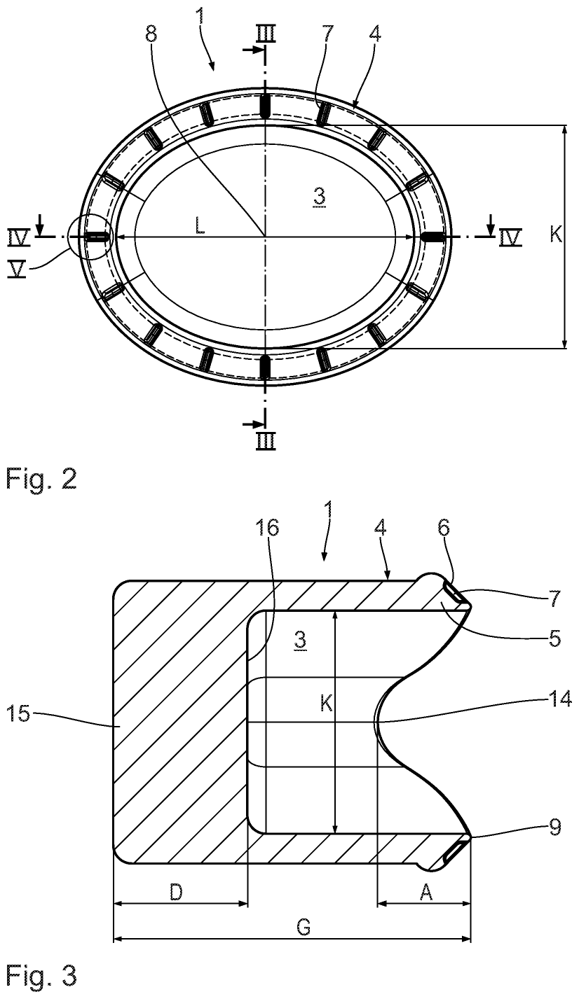

Details of the preparation cuff 1 can be seen in FIGS. 1 to 5.

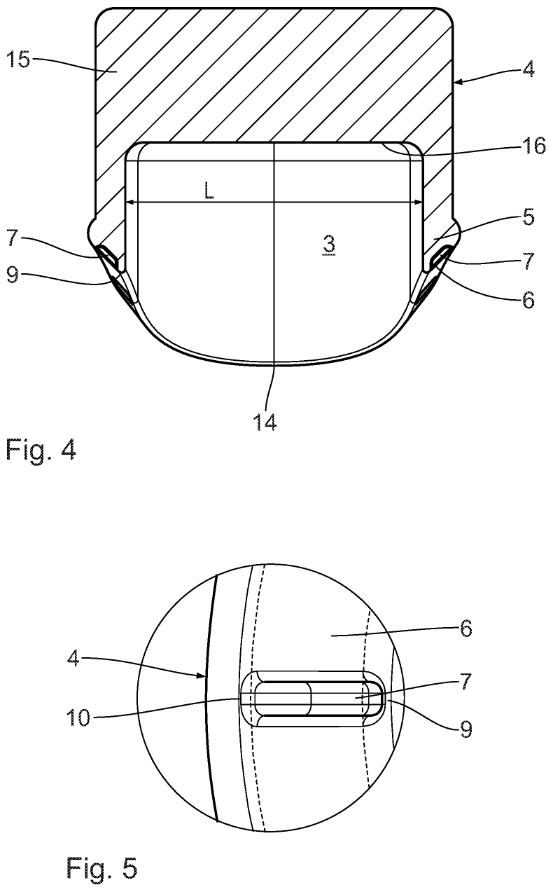

The preparation cuff 1 has a tooth opening 3 to place on the tooth. The tooth opening 3 is circumferentially bounded by a peripheral wall 4, which (cf. FIGS. 3 and 4) has a cross-sectionally wedge-shaped edge region 5 tapering radially inwards, i.e. towards the tooth opening 3. In the edge region 5, an outer wall thickness of the peripheral wall 4 is raised in the manner of a bead.

The preparation cuff 1 is manufactured from a material with a Shore hardness in the range between 70A and 95A. The Shore hardness can be 75A, 80A or 85 A. The material may be a thermoplastic elastomer (TPE). The material can be a polyurethane (PUR), a polyethylene (PE), a polypropylene (PP), a polyether block amide (PEBAX, PEBA), a silicone (SIK).

An outer wedge wall portion 6 of the edge region 5 of the peripheral wall 4 has a plurality of recesses 7 which are set back with respect to the respective surrounding wedge wall portion 6. In the embodiment according to FIGS. 1 to 5, the preparation cuff 1 has sixteen such recesses 7. Another number of such recesses in the range between 1 and 100 is also possible. The recesses 7 run approximately radially to a longitudinal axis 8 of the preparation cuff 1 running centrally in the tooth opening 3. A circumferential inner web 9 remains between the respective recess 7 and an inner peripheral edge region of the peripheral wall 4, which bounds a circumference of the tooth opening 3. A circumferential outer web 10 remains between the respective recess 7 and an outer peripheral edge region of the peripheral wall 4, which bounds an outer circumference of the preparation cuff 1 in the region of the tooth opening 3. The respective recess 7 is thus fully bounded by non-recessed parts of the outer wedge wall portion 6.

The peripheral wall 4 and thus the tooth opening 3 has a cross-section deviating from a circular shape. In the embodiment according to FIGS. 1 to 5, the peripheral wall 4 has a cross-section around the tooth opening 3 which is elliptical in shape with a main axis ratio between a long main axis L and a short main axis K of about 1.35. Depending on the embodiment of the preparation cuff 1, this main axis ratio L/K may also have another value in the range of, for example, between 1.1 and 1.5, especially between 1.3 and 1.4. Depending on the embodiment of the preparation cuff 1, the cross-section of the tooth opening 3, which is bounded by the peripheral wall 4, can also be configured to be oval, for example.

As can be seen from the perspective illustration according to FIG. 1 and from a synopsis of the sectional views according to FIGS. 3 and 4, the peripheral wall 4 has a wave-shaped axial contour with two axial maximum extension regions 11, 12 and two axial minimum extension regions 13, 14. An axial spacing A between the maximum extension regions 11, 12 on the one hand and the minimum extension regions 13, 14 on the other hand lies approximately in the range of the smaller main axis extension K/2 of the elliptical cross-section of the peripheral wall 4 or of the tooth opening 3. Depending on the embodiment of the preparation cuff 1, this axial spacing A can be between 0.8 times and 1.2 times the smaller main axis extension K/2.

The tooth opening 3 is configured as a blind opening. A bottom 15 of the tooth opening 3 has a thickness D which is greater than a quarter of a total extension G of the preparation cuff 1 perpendicular to a bottom surface 16 of the bottom 15 of the tooth opening 3.

The preparation cuff 1 can be manufactured in its entirety by means of 3D printing. As an alternative to a 3D printing method, the preparation cuff can also be produced by an injection molding method, an extrusion or compression molding method.

The preparation cuff 1 is either a single piece or is part of a set of multiple preparation cuffs of the same type as the preparation cuff 1 with different widths and/or different depths of the tooth openings 3, adapted to the respective tooth size or tooth anatomy of the patient.

The preparation cuffs 1 of the set can also differ with regard to the dimension for the axial spacing A between the maximum extension regions and the minimum extension regions of the peripheral wall 4. Differences can also arise in the various preparation cuffs 1 of the set with regard to the respective circumferential extensions of the extension regions 11 to 14.

When preparing, in particular, a crown impression for a tooth to be treated, a preparation cuff 1 is first produced as a single piece or a suitable preparation cuff 1 for the tooth to be treated is selected from the preparation cuff set. In this case, a preparation cuff 1 is selected whose tooth opening 3 is undersized compared to the circumference of the tooth to be treated so that the preparation cuff 1 can be snugly fitted and pushed onto the tooth. The wave-shaped axial contour of the peripheral wall 4 is aligned by rotating the preparation cuff 1 about the longitudinal axis 8 after pre-positioning on the tooth to be treated so that the minimum extension regions assume peripheral positions in the region of adjacent teeth.

Now the preparation cuff 1 is pushed completely onto the tooth to be treated, wherein the wedge-shaped tapering edge region 5 penetrates between the tooth neck of the tooth and the gums surrounding same, thereby displacing the gums surrounding the tooth to be treated in the transition region between the tooth neck of the tooth to be treated and the surrounding gums. Exposure pressure can be applied by the patient biting over the opposing jaw. Once displacement has occurred, the preparation cuff 1 can be removed and the transition region between the tooth neck of the tooth to be treated and the surrounding gums remains exposed for a period of time. In this situation, an impression of the tooth to be treated including the exposed transition region can then be made with usual impression material.

Before placing the preparation cuff 1 on the tooth to be treated, the recesses 7 can be loaded with a medicament that reduces irritation or bleeding of the displaced gums during the use of the preparation cuff 1 or prevents such irritation or bleeding.

When using a 3D printing method, an optical or analogue pre-impression of the pre-prepared tooth can be made after the preparation of the tooth to be treated. With the aid of an appropriate software, an individual preparation cuff 1 is then designed that is adapted to the anatomy of the pre-prepared tooth. This individually designed preparation cuff can then be produced in the course of 3D printing.

In the case of preparation cuffs, which are manufactured in particular by an injection molding method or extrusion method, the dentist selects a corresponding variant and attaches the latter. This preparation cuff 1 is selected such that it fits snugly on the tooth and adapts to the tooth due to its flexibility.

A set can include two to 20 preparation cuffs of different dimensions according to the type of preparation cuff 1. Alternatively, individual production or use of the respective preparation cuff 1 is possible.

1. A dental preparation cuff (1) for exposing a transition region (preparation margin) between a tooth neck of a prepared tooth and surrounding gums (2),
having a tooth opening (3) to place on the tooth, having a peripheral wall (4) with a cross-sectionally wedge-shaped, radially inwardly tapering edge region (5),
manufactured from a material having a shore hardness in the range between 70A and 95A.

2. The preparation cuff according to claim 1, wherein an outer wedge wall portion (6) of the peripheral wall (4) has at least one recess (7) which is set back with respect to the outer wedge wall portion (6).

3. The preparation cuff according to claim 2, wherein a circumferential inner web (9) remains between the at least one recess (7) and an inner peripheral edge region of the peripheral wall (4) which bounds a circumference of the tooth opening (3).

4. The preparation cuff according to claim 2, wherein a circumferential outer web (10) remains between the at least one recess (7) and an outer peripheral edge region of the peripheral wall (4), which bounds an outer circumference of the preparation cuff (1) in the region of the tooth opening (3).

5. The preparation cuff according to claim 1, wherein the peripheral wall (4) has a cross-section that deviates from a circular shape.

6. The preparation cuff according to claim 5, wherein the cross-section of the peripheral wall (4) is configured to be elliptical with a main axis ratio (L/K) in the range between 1.1 and 1.5.

7. The preparation cuff according to claim 5, wherein the peripheral wall (4) has a wave-shaped axial contour with two axial maximum extension regions (11, 12) and two axial minimum extension regions (13, 14).

8. The preparation cuff according to claim 6, wherein an axial spacing (A) between the maximum extension regions (11, 12) and the minimum extension regions (13, 14) is implemented in the range between 0.8 times and 1.2 times a smaller main axis extension (K/2) of the elliptical cross-section of the peripheral wall (4).

9. The preparation cuff according to claim 1, wherein the tooth opening (3) is configured as a blind opening, wherein a bottom (15) of the tooth opening (3) has a thickness (D) which is greater than a quarter of a total axial extension (G) of the preparation cuff (1) perpendicular to a bottom surface (16) of the bottom (15).

10. The preparation cuff according to claim 1, manufactured by a 3D printing method.

11. A set of multiple preparation cuffs according to claim 1 with at least one of different widths and different depths of the tooth openings (3) and different axial spacings (A) between the maximum extension regions (11, 12) and the minimum extension regions (13, 14).
